(19) United States
(12) Patent Application Publication
(10) Pub. No.: US 2005/0050248 A1
(43) Pub. Date: Mar. 3, 2005

(54) Portable electronic instrument with field-replaceable battery/input/output module

(76) Inventor: Dennis York, Corvallis, OR (US)

Correspondence Address: WAGNER, MURABITO & HAO LLP;Third Floor, Two North Market Street, San Jose, CA, 95113, US

(21) Appl. No.: 10/651,586

(22) Filed: Aug. 29, 2003

(51) Int. Cl. G06F 13/12; G06F 13/38

(52) U.S. Cl. 710/72

(57) ABSTRACT

A portable electronic instrument comprising a processing unit and a combined power and input/output module. The module includes a plurality of electrical contacts for mating to complementary contacts on a processing unit. The mating surfaces of the processing unit and module are shaped to provide a seal for the contacts when the module is attached to the instrument. The plurality of electrical contacts are connected to external ports that are accessible when the module is attached to the instrument. These ports may include DC power, AC power, and electric signal inputs and outputs. The module also includes mechanical features that enable it to be secured in the mated position with respect to the processing unit. These features may include interlocking tabs or holes for accepting screws. The module houses an energy storage device that may be a battery or a capacitor for providing power to the processing unit.

### FIELD OF THE INVENTION

The present claimed invention relates to the field of portable electronic instruments. More particularly, the present claimed invention relates to battery powered portable instruments with input/output (I/O) ports.

### BACKGROUND ART

Many portable instruments such as those used in surveying and construction are intended for use in demanding outdoor environments. Dirt and moisture can lead to corrosion and abrasive wear, and the potential for impact damage is high.

Susceptibility to damage particularly an issue when an instrument has an I/O capability that requires the insertion and removal of connectors. Although connectors may be designed to resist contamination, and may be shielded from impact, they are vulnerable during the making and breaking of connections. Replacement, repair, or cleaning of integrated I/O ports is not easily accomplished in the field, if it can be done at all.

The problems associated with degradation or damage of integrated I/O ports on portable instruments is exacerbated by the increasing data transfer rates for I/O protocols, and the decreasing size and spacing of connector contacts. For example, the Universal Serial Bus (USB) port has a higher data transfer rate and smaller form factor than the typical RS-232 port.

Portable instruments frequently rely on batteries for power, and these may be housed in a chamber inside the instrument behind a sealed door. Although the sealed door may provide adequate protection during use, the operation of replacing batteries exposes the interior of the device to contamination. Cleaning of the chamber is often difficult, particularly when the chamber is not physically separated from the remainder of the instrument interior. The migration of contaminants from the battery chamber can lead to instrument failure.

Further, batteries deteriorate with time and typically have a higher failure rate than the electronics they power. Their expected field life is similar to that of the connectors described above.

Thus a need exists for I/O connections for portable electronic instruments that can easily be easily replaced during field use to minimize operational downtime. There is also a need for a battery system that allows for battery replacement that minimizes the potential for instrument degradation.

### SUMMARY OF INVENTION

Accordingly, the present invention provides an instrument with a field-replaceable module that contains both batteries and I/O ports. The module allows for rapid replacement of the instrument power supply and data interface while eliminating the exposure of the instrument interior to contamination

A portable electronic instrument comprising a processing unit and a combined power and input/output module is disclosed. The module includes a plurality of electrical contacts for mating to complementary contacts on a processing unit. The mating surfaces of the processing unit and module are shaped to provide a seal for the contacts when the module is attached to the instrument. The plurality of electrical contacts is connected to external ports that are accessible when the module is attached to the instrument. These ports may include DC power, AC power, and electric signal inputs and outputs. The module also includes mechanical features that enable it to be secured in the mated position with respect to the processing unit. These features may include interlocking tabs or holes for accepting screws. The module houses an energy storage device that may be a battery or a capacitor for providing power to the processing unit.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 shows a top view of a processing unit and a battery/input/output module in accordance with an embodiment of the present claimed invention.

FIG. 2 shows a bottom view of a processing unit and a battery/input/output module in accordance with an embodiment of the present claimed invention.

FIG. 3 shows an end view of a processing unit and a battery/input/output module in accordance with an embodiment of the present claimed invention.

FIG. 4 shows a back perspective view of the assembled processing unit and battery/input/output module in accordance with an embodiment of the present claimed invention.

FIG. 5 shows a front perspective view of the assembled processing unit and battery/input/output module in accordance with an embodiment of the present claimed invention.

### DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances well known methods, procedures, components, and circuits have not been described in detail as not to unnecessarily obscure aspects of the present invention.

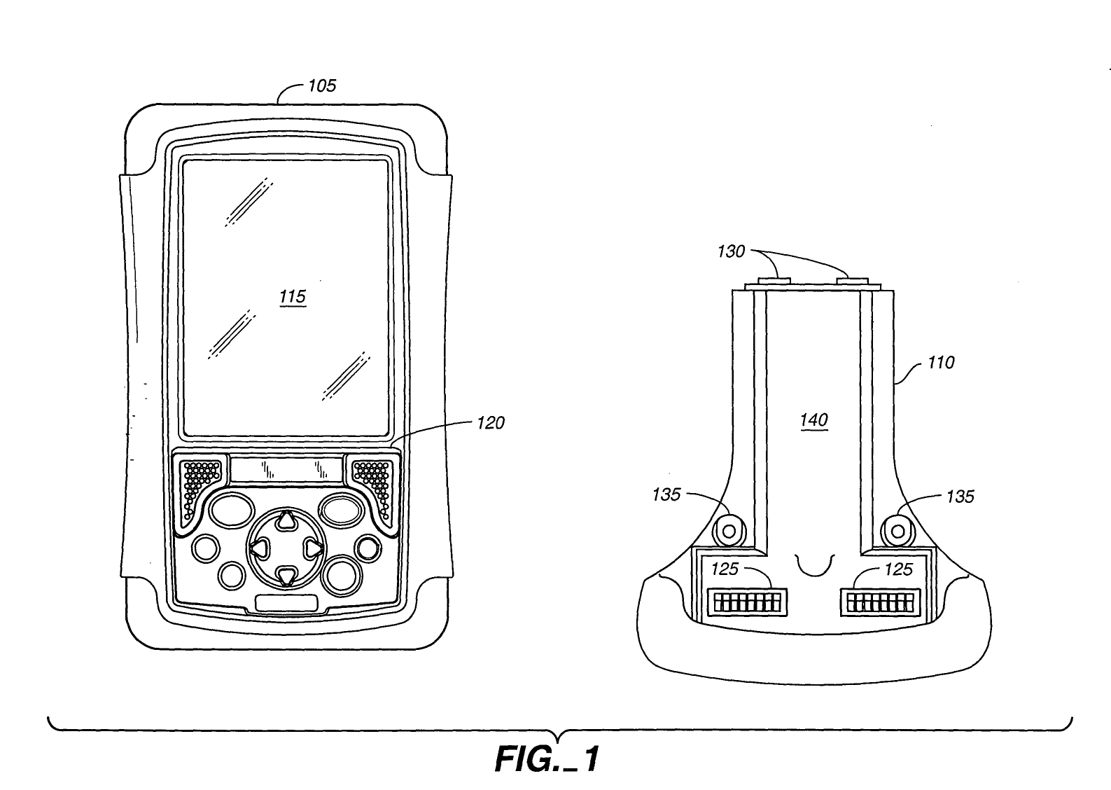

FIG. 1 shows a top view of a handheld instrument comprising a processing unit 105 and a battery/input/output module 110 in accordance with an embodiment of the present invention.

The processing unit 105 may include a display 115. The display 115 may be a touch panel display. The processing unit 105 may also include a keypad 120 for command and data entry.

The processing unit comprises a signal/data processor that may be used to process digital or analog signals. For example, the processor may be a digital microprocessor, with the processing unit being a handheld computer. Alternatively, the processor may include an analog functionality, such as radio frequency reception. In general, the processing unit provides input and/or output functionality for a human user, as well as analog and/or digital signal processing capability.

The processing unit may include a field programmable gate array (FPGA) that provides digital and/or analog processing, as well as communications functionality. Application specific integrated circuits (ASICs) may also be used to provide functionality such as a global positioning system (GPS). The processor may also comprise volatile memory such as random access memory (RAM), or non-volatile memory such as flash memory.

The battery/input/output module 110 comprises a plurality of exposed external electrical contacts 125. There is at least one contact for the transmission of electrical power, and one or more contacts for the transmission and reception of electrical signals. An individual contact may be used for both reception and transmission of electrical signals.

The contacts may be molded into the body of the battery/input/output module 110 in order to provide a weather tight seal that is proof against moisture and dirt. The contacts may also be mounted with a low profile so that cleaning is simplified.

The housing of the battery/input/output module 110 comprises mechanical retention features such as tabs 130 or screw holes 135 for securely attaching the module to a processing unit.

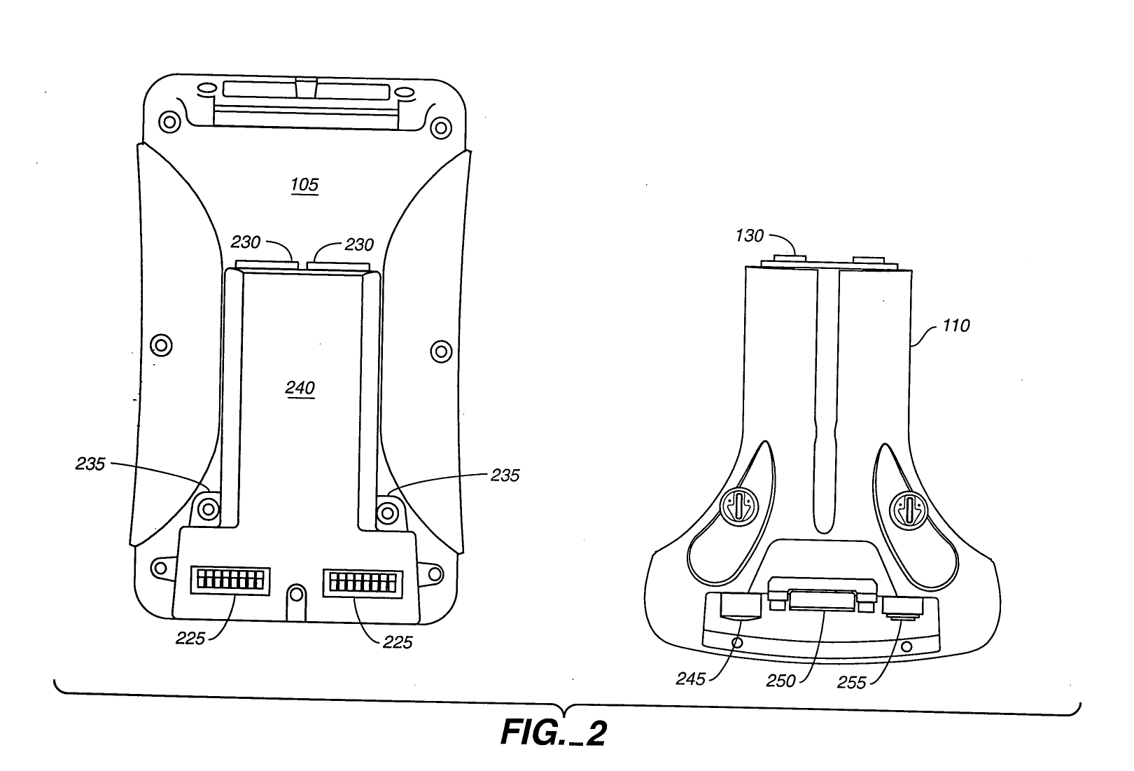

FIG. 2 shows a bottom view of the processing unit 105 and the battery/input/output module 110. The processing unit 105 comprises a mating surface 240 that corresponds with a mating surface 140 (FIG. 1) of the battery/input/output module 110. In this way, the module 110 serves as a cover for the unit 105, and vice versa. The surfaces 240 and 140 are shaped to provide a close fit that prevents contamination from reaching the contacts when assembled. Either surface 140 or 240 may also be fitted with an O-ring or gasket to provide a weather tight seal.

The processing unit 105 comprises mechanical retention features such as detents 230 for accepting tabs 130, or tapped screw holes 235 for securely attaching the processing unit to the module 110. The unit 105 also comprises a plurality of electrical contacts 225 that correspond with the contacts 125.

The battery/input/output module 110 comprises a universal serial bus (USB) port 245, serial port 250 and a power port 255. In general, either serial or parallel communications ports may be used, and may provide connector strain relief as shown for the serial port 250. Each of the ports 245, 250, and 255 are coupled to one or more of the contacts 125.

The battery/input/output module 110 houses a rechargeable energy storage device that is coupled to at least one of the contacts 125. The rechargeable energy storage device may be a battery or a capacitor. The energy storage device may be recharged by connecting an external power source to the power port 255. Alternatively, the energy storage device may be charged by inductively coupling to a recharging circuit sealed within the module 110. In either case, the assembled instrument may be configured to be operated while recharging the energy storage device.

The module 110 may also house a wireless communications device (e.g. Bluetooth) that is coupled to at least one of the contacts 125. Although a wireless device may be embedded within the processing unit 105, embedding within the module 110 reduces the size of the processing unit 110 and maintains flexibility in input/output capability.

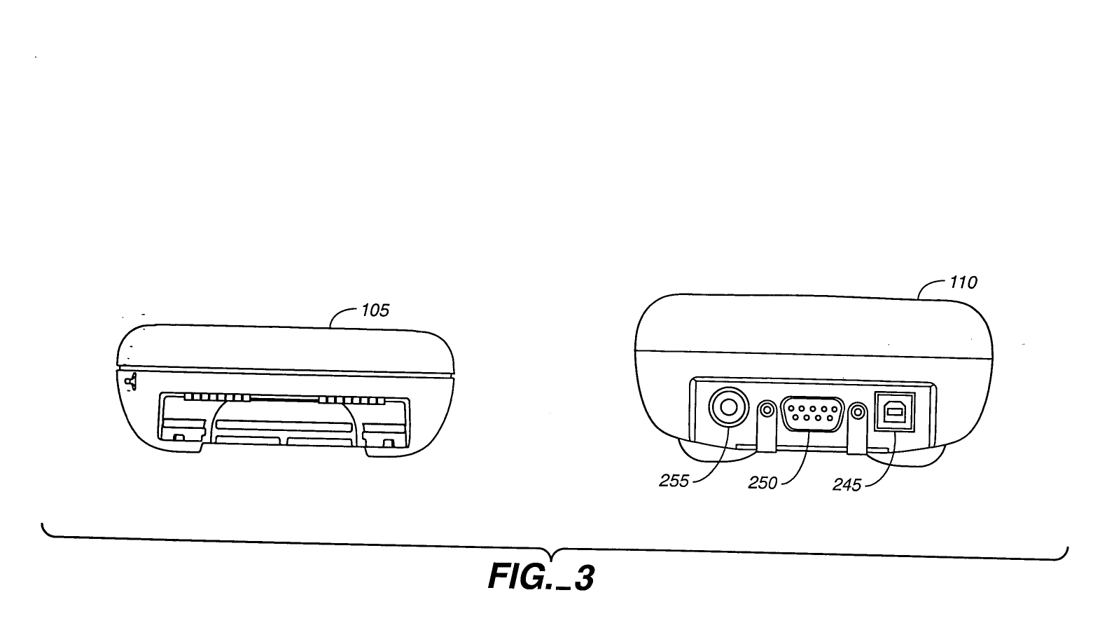

FIG. 3 shows an end view of the processing unit 105 and the battery/input/output module 110. The ports 245, 250, and 255 are recessed to protect against impact. The housing of the module 110 may be molded from a resilient material, allowing the module to provide mechanical shock resistance to the embedded components. The module 110 may also be shaped to wrap around the processing unit 105 to provide shock resistance for the processing unit 105.

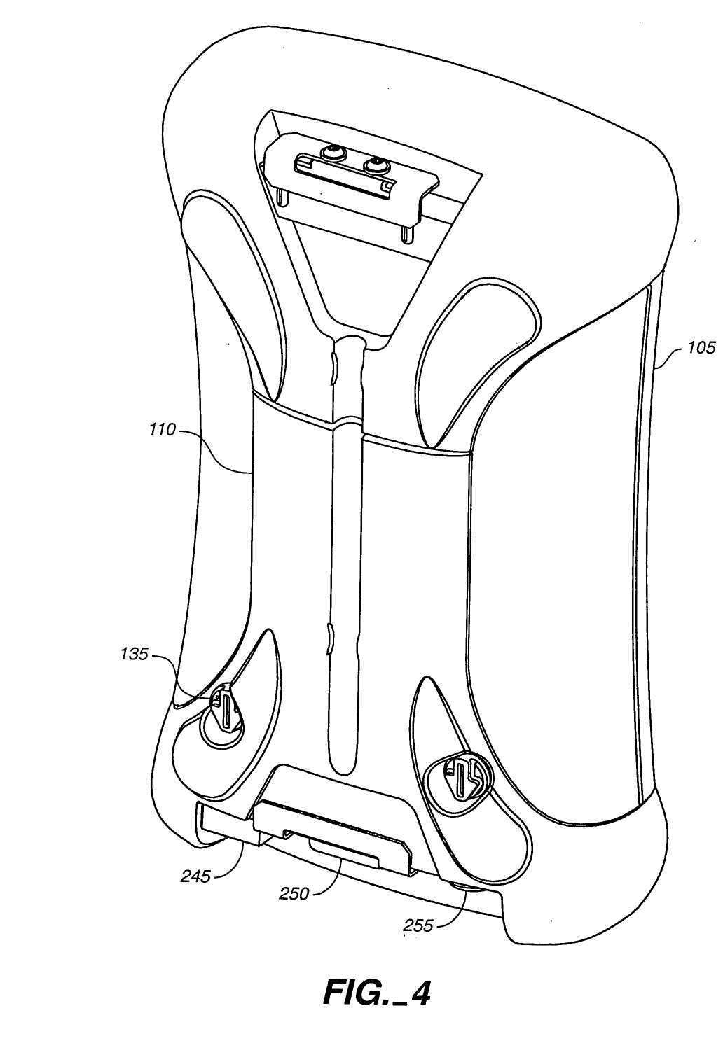

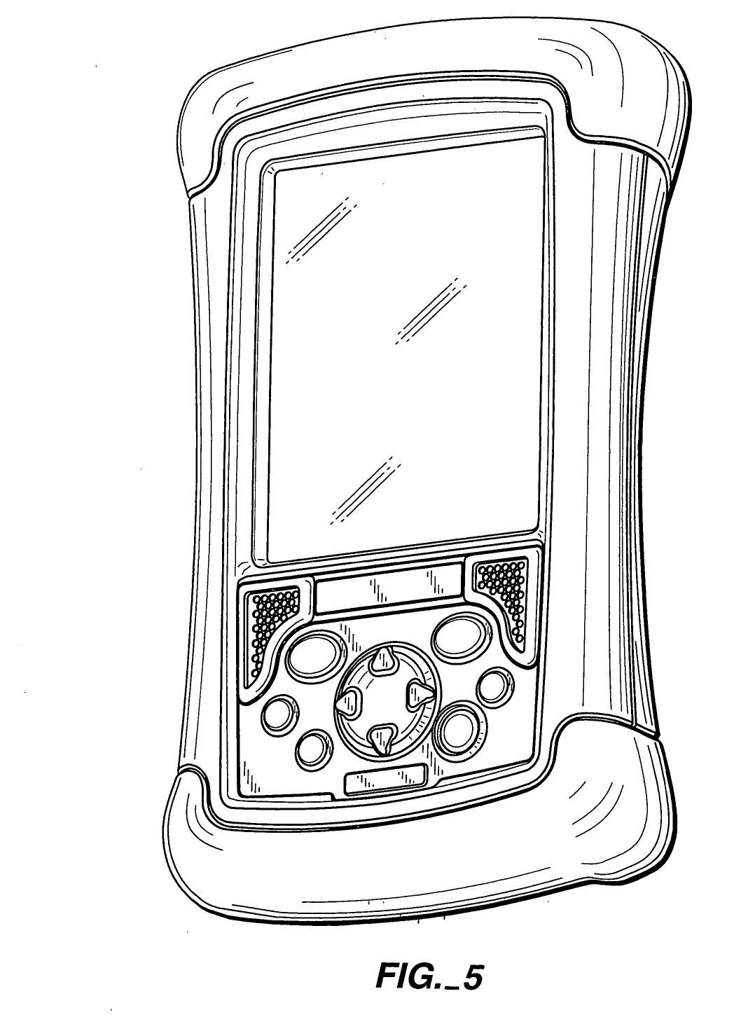

FIG. 4 shows a back perspective view of an assembled processing unit and battery/input/output module in accordance with an embodiment of the present invention. FIG. 5 shows a front perspective view of the assembled processing unit and battery/input/output module of FIG. 4.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications are suited to the particular use contemplated. It is intended that the scope of the invention be defined by the claims appended hereto and their equivalents.

1. A processing unit for an electronic instrument comprising:
a signal/data processor;
an exposed external electrical contact for receiving electric power input;
an exposed external electrical contact for receiving an electric signal input;
an exposed external electrical contact for transmitting an electrical signal output; and
a housing comprising mechanical retention features for securely attaching a battery/input/output module.

2. The processing unit of claim 1, wherein said processing unit comprises a memory.

3. The processing unit of claim 1, wherein said processing unit comprises a keypad.

4. The processing unit of claim 1, wherein said processing unit comprises a microprocessor.

5. The processing unit of claim 1, wherein the contacts may be sealed through the attachment of a cover to the surface of said housing.

6. The processing unit of claim 1, wherein said processing unit comprises a display.

7. The processing unit of claim 6, wherein said display is a touch panel display.

8. A battery/input/output module for an electronic instrument comprising:
a storage device for electric energy;
an exposed external electrical contact for transmitting electric power;
an exposed external electrical contact for receiving an electric signal input;
an exposed external electrical contact for transmitting an electrical signal output;
a housing comprising mechanical retention features for securely attaching a processing unit.

9. The battery/input/output module of claim 8, wherein the contacts may be sealed through the attachment of a cover to the surface of said housing.

10. The battery/input/output module of claim 8, further comprising a serial port electrically coupled to said exposed electrical contact for transmitting an electrical signal output.

11. The battery/input/output module of claim 8, further comprising a parallel port electrically coupled to said exposed electrical contact for transmitting an electrical signal output.

12. The battery/input/output module of claim 8., further comprising a wireless transceiver for data communications electrically coupled to said exposed electrical contact for transmitting an electrical signal output.

13. The battery/input/output module of claim 8, further comprising an embedded inductive charger for said energy storage device.

14. The battery/input/output module of claim 8, further comprising a power input port for charging said energy storage device.

15. A portable electronic instrument comprising a processing unit coupled to a battery/input/output module.

16. The portable electronic instrument of claim 15, wherein said portable electronic instrument is sealed.

17. The portable electronic instrument of claim 15, wherein said portable electronic instrument may be powered by coupling an external power source to said battery/input/output module.

18. The portable electronic instrument of claim 17, wherein said external power source may be inductively coupled to said battery/input/output module.

19. The portable electronic instrument of claim 15, wherein said portable electronic instrument is a handheld computer.

20. The portable electronic instrument of claim 15, wherein said portable electronic instrument comprises a global positioning system (GPS).
